(19) United States
(12) Patent Application Publication
(10) Pub. No.: US 2026/0322302 A1
(43) Pub. Date: Oct. 15, 2026

(54) ROTATING MACHINE CONTROL DEVICE

(71) Applicant: Mitsubishi Electric Corporation, Tokyo (JP)

(72) Inventors: Shota KONDO, Tokyo (JP); Masahiro IEZAWA, Tokyo (JP)

(73) Assignee: Mitsubishi Electric Corporation, Tokyo (JP)

(21) Appl. No.: 19/104,373

(22) PCT Filed: Aug. 23, 2022
(86) PCT No.: PCT/JP2022/031658

§ 371 Date: Feb. 18, 2025

(51) Int. Cl. H02P 27/08; H02P 21/22

(52) U.S. Cl. CPC H02P 27/08; H02P 21/22

(57) ABSTRACT

A rotating machine control device includes a voltage command generator which generates a voltage command value, a carrier-wave generation unit, and a comparator which determines switching operation of the power converter using the voltage command value and output of the carrier-wave generation unit. The carrier-wave generation unit includes a carrier-wave corrector for correcting the frequency of a carrier wave. Under a condition that increase in the number of times of switching per cycle of electric angle is suppressed as much as possible, switching is performed so as not to increase peak current in a region where the magnitude of a current value in current information on the rotating machine is more than a predetermined magnitude, whereby increase in the peak current is suppressed without increasing loss due to the switching operation, so that the rotating machine and the power converter are protected.

### TECHNICAL FIELD

The present disclosure relates to a rotating machine control device.

### BACKGROUND ART

When a control device for a rotating machine performs pulse width modulation (PWM) control for the rotating machine in a high-speed rotation region, synchronous PWM control is generally used to ensure that the voltage pulses are symmetrical per cycle of electric angle. Regarding the synchronous PWM control, triangular-wave-comparison synchronous PWM control that determines the PWM duty through comparison of a triangular wave and a modulation signal can maintain the symmetry of voltage pulses with a simple configuration, and thus is widely used.

Meanwhile, it is desired that the number of times of switching operation is made as small as possible to reduce loss due to the switching operation. Here, the number of times of switching operation is defined as the number of times of switching operation performed by a power converter per cycle of electric angle, that is, the sum of the number of times of turning ON and the number of times of turning OFF. For example, in the synchronized nine-pulse mode, the number of times of switching operation is 18. In the synchronized six-pulse mode, the number of times of switching operation is 12. When the number of times of switching is reduced, voltage harmonics and current harmonics are increased, thereby causing a problem that the peak of phase current (hereinafter, peak current) is increased. In application such as factory automation (FA), an air conditioner, a working machine, an aircraft, a train, and an automobile in which a rotating machine control device is used, if increase in the peak current cannot be sufficiently suppressed, demagnetization and element breakage are caused. Thus, it is desired to achieve reduction in both the number of times of switching and peak current.

For example, in Patent Document 1, in the configuration of asynchronous PWM control in a triangular wave comparison method, a carrier wave frequency is raised in a region where the amplitude of phase current is great, whereby increase in peak current is suppressed. In Patent Document 2, in the configuration of synchronous PWM control in a triangular wave comparison method, a carrier wave frequency in a specific one cycle of a carrier wave is multiplied by an integer and a period in which the carrier wave frequency is multiplied by an integer does not span two cycles, whereby increase in electromagnetic noise is suppressed.

### CITATION LIST

### Patent Document

Patent Document 1: Japanese Laid-Open Patent Publication No. 2-168895
Patent Document 2: Japanese Laid-Open Patent Publication No. 2012-235619

### SUMMARY OF THE INVENTION

### Problem to be Solved by the Invention

The configuration of Patent Document 1 or 2 can suppress increase in peak current but has a problem of increasing the number of times of switching. In addition, the number of patterns that can be used as a carrier wave shape is small, and the effect of suppressing increase in the peak current is small. In addition, for reducing the peak current, if a carrier wave frequency is raised and the number of times of switching is increased, heat in a chip of an inverter which is a switching element becomes high, resulting in failure of the inverter.

The present disclosure has been made to solve the above problems, and an object of the present disclosure is to suppress increase in peak current without increasing loss due to switching operation and to protect a rotating machine and a power converter.

### Means to Solve the Problem

A rotating machine control device according to the present disclosure is for applying AC voltage of DC voltage supplied from a DC power supply, to a rotating machine through a power converter, and includes: a voltage command generator which generates a voltage command value; a carrier-wave generation unit which generates a carrier wave; and a comparator which determines switching operation of the power converter using the voltage command value and output of the carrier-wave generation unit, wherein the carrier-wave generation unit includes a carrier-wave corrector which corrects a frequency of a carrier wave as a reference, and with respect to the frequency of the carrier wave as the reference, the carrier-wave corrector performs correction such that a frequency of the carrier wave is raised by a factor of more than 1.0, at least in a part of a region where a magnitude of a current value in current information on the rotating machine is more than a predetermined magnitude, and performs correction such that the frequency of the carrier wave is lowered by a factor of 1.0 or less, at least in a part of a region where the magnitude of the current value in the current information on the rotating machine is less than the predetermined magnitude, or the carrier-wave corrector performs correction such that the frequency of the carrier wave is raised by a factor of 1.0 or more, at least in a part of the region where the magnitude of the current value in the current information on the rotating machine is more than the predetermined magnitude, and performs correction such that the frequency of the carrier wave is lowered by a factor of less than 1.0, at least in a part of the region where the magnitude of the current value in the current information on the rotating machine is less than the predetermined magnitude.

### Effect of the Invention

In the rotating machine control device according to the present disclosure, under a condition that increase in the number of times of switching per cycle of electric angle is suppressed as much as possible, switching is performed so as not to increase peak current in a region where the magnitude of the current value in the current information on the rotating machine is more than the predetermined magnitude, whereby increase in the peak current is suppressed without increasing loss due to switching operation, so that the rotating machine and the power converter can be protected.

### BRIEF DESCRIPTION OF THE DRAWINGS

FIG. 1 is a hardware configuration diagram of a rotating machine control device according to embodiment 1.

FIG. 2 is a function block diagram of the rotating machine control device according to embodiment 1.

FIG. 3 is a block diagram illustrating an internal configuration of a carrier-wave generation unit according to embodiment 1.

FIG. 4 is a block diagram illustrating an internal configuration of a carrier-wave corrector according to embodiment 1.

FIG. 5 is a block diagram illustrating an internal configuration of a carrier-wave calculator according to embodiment 1.

FIG. 6 illustrates a carrier wave generated by a rotating machine control device in a comparative example.

FIG. 7 illustrates a carrier wave obtained by correcting a carrier wave frequency in the rotating machine control device according to embodiment 1.

FIG. 8 illustrates a carrier wave obtained by correcting a carrier wave frequency and a carrier wave phase in the rotating machine control device according to embodiment 1.

FIG. 9 illustrates a carrier wave obtained by correcting a carrier wave frequency and a carrier wave phase, in a case where a phase difference between voltage and current is great in the rotating machine control device according to embodiment 1.

### DESCRIPTION OF EMBODIMENT

Hereinafter, a preferred embodiment of the rotating machine control device according to the present disclosure will be described with reference to the drawings. The same or corresponding things and parts are denoted by the same reference characters and the detailed description thereof is omitted.

### Embodiment 1

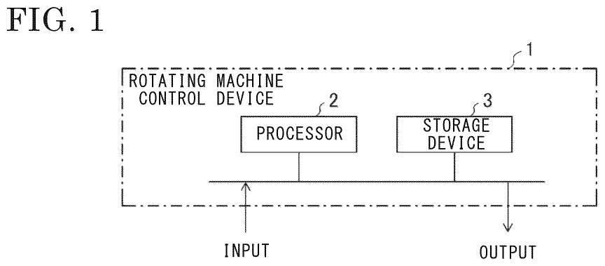

One example of hardware of a rotating machine control device 1 of the present disclosure is shown in FIG. 1. The rotating machine control device 1 is composed of a processor 2 and a storage device 3. Although not shown, the storage device 3 includes a volatile storage device such as a random access memory, and a nonvolatile auxiliary storage device such as a flash memory. The storage device 3 may include an auxiliary storage device such as a hard disk, instead of a flash memory.

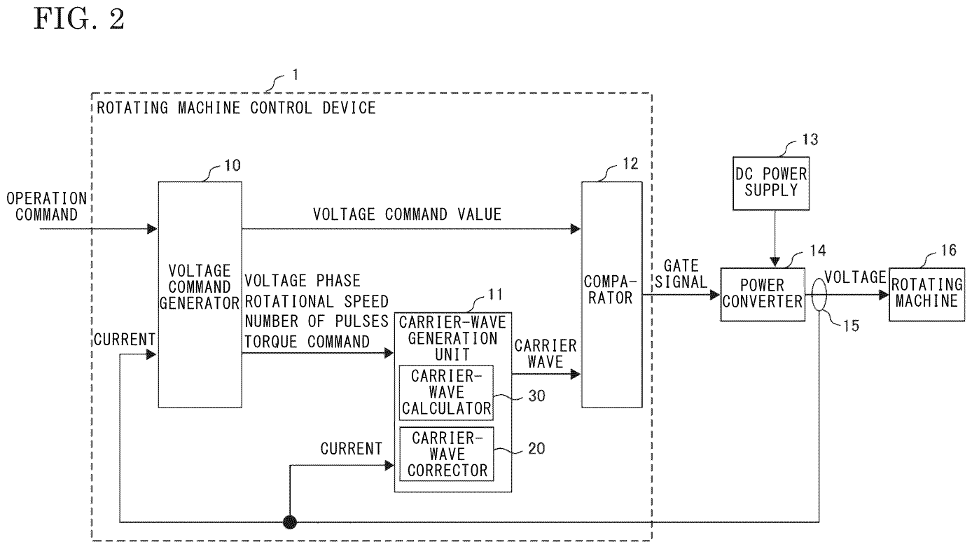

FIG. 2 is a function block diagram of the rotating machine control device of the present embodiment. The rotating machine control device 1 includes a voltage command generator 10, a carrier-wave generation unit 11, and a comparator 12. A gate signal for performing ON/OFF control of a switching element of a power converter 14 is transmitted from the comparator 12, and voltage supplied from a DC power supply 13 is converted to AC voltage. The converted AC voltage is applied to a rotating machine 16, to drive the rotating machine 16. Hereinafter, each configuration in the rotating machine control device 1 will be described in detail.

The voltage command generator 10 generates a voltage command value, a voltage phase, a rotational speed, the number of pulses, and a torque command on the basis of an inputted operation command and current information. Here, the operation command refers to a command torque, a command rotational speed, a current command, etc. which are inputted to the voltage command generator from the outside. The current information is detected from currents for respective phases of the rotating machine 16. As the current information, a detected-current value detected by a current detector 15, a current command value, or an estimated-current value estimated or predicted from rotating machine characteristics may be used, as described below. The generated voltage command value is outputted to the comparator 12. In addition, the voltage phase, the rotational speed, the number of pulses, and the torque command which have been generated are outputted to the carrier-wave generation unit 11. The current information is also inputted to the carrier-wave generation unit 11. The voltage phase may be included as a part of information on the voltage command value.

In a method for generating the voltage command value, for example, the operation command is converted to a current command, and current vectors thereof are controlled in a rotating coordinate system (d-q coordinate system), whereby a three-phase voltage command value can be obtained. In addition, a three-phase voltage command value corresponding to a command rotational speed as in V/f constant control may be obtained.

The voltage phase is obtained from a rotor position detected or estimated by using a device such as a resolver or an encoder (not shown) which is a position detector mounted to the rotating machine 16, and the phases of voltage vectors obtained from the three-phase voltage command value.

As the rotational speed, a value obtained through calculation using the rotor position, or a value detected by a speed detector is used.

The number of pulses refers to the number of voltage pulses for performing switching operations in one cycle of electric angle, and is also the number of carrier waves. The number of carrier waves is the number of carrier wave cycles in one cycle of electric angle, and, when the carrier wave is a triangular wave, is equal to the number of the tops and the bottoms thereof. The number of pulses is determined at least on the basis of the rotational speed, and is determined according to noise, harmonics, torque, vibration, a calculation cycle, and the like with respect to switching. As the number of pulses, for example, an odd number such as 15, 9, 5, or 3 is often selected because of the symmetry of the pulse waveform, but an even number such as 12 or 6 may be selected, and a number including a decimal fraction may be selected in a case where the number of pulses is managed in a plurality of cycles of electric angle. For example, if the number of pulses per cycle of electric angle is selected as 15.1, 9.8, or 6.5, the number of pulses will be 151, 98, or 65 over 10 cycles of electric angle, respectively.

The carrier-wave generation unit 11 includes a carrier-wave corrector 20 and a carrier-wave calculator 30, and generates a carrier wave, on the basis of the current information, and the voltage phase, the rotational speed, the number of pulses, and the torque command which have been generated by the voltage command generator 10. The generated carrier wave is outputted to the comparator 12. The frequency of the carrier wave is generated as a product of a coefficient and the frequency of the voltage command value.

The comparator 12 compares the magnitudes of the voltage command value and the carrier wave, using the voltage command value generated by the voltage command generator 10 and the carrier wave generated by the carrier-wave generation unit 11, to generate a PWM waveform, and outputs the gate signal to the power converter 14. That is, switching operation of the power converter 14 is determined by the comparator 12 using the voltage command value and the carrier wave.

The gate signal outputted from the comparator 12 of the rotating machine control device 1 is inputted to the power converter 14. The power converter 14 is connected to the DC power supply 13 and the rotating machine 16 via wiring, and generates AC voltage from DC voltage supplied from the DC power supply 13 on the basis of the gate signal, and the AC voltage is applied to the rotating machine 16. As a matter of course, when the rotational speed comes close to 0, AC current and AC voltage become DC current and DC voltage, and AC current and AC voltage include not only an AC component but also a DC component when an offset component is contained.

The current detector 15 detects currents iu, iv, iw for the respective phases, U phase, V phase, and W phase, of the rotating machine 16. Instead of the current detected by the current detector 15, the current command value for a part or all of the respective phases may be used, or a current estimator for predicting or estimating current from rotating machine characteristics represented by the following equation (1) may be used. In addition, current on a DC bus side may be detected to calculate currents for the respective phases. The current estimator is used as a substitute for the current detector 15 to reduce the cost in some cases. In a case where the current estimator is also used as the substitute when accuracy and response of the current detector 15 are low, current that transiently varies can be assuredly observed.

$$[ Mathematical 1 ]$$

$$[ \begin{matrix}{v}_{u} \\ {v}_{v} \\ {v}_{w}\end{matrix} ] = [ \begin{matrix}R + {sL}_{u} & {sM}_{uv} & {sM}_{wu} \\ {sM}_{uv} & R + {sL}_{v} & {sM}_{vw} \\ {sM}_{wu} & {sM}_{vw} & R + {sL}_{w}\end{matrix} ] [ \begin{matrix}{i}_{u} \\ {i}_{v} \\ {i}_{w}\end{matrix} ] + {ω}_{re} {ϕ}_{mag} [ \begin{matrix}- sin {θ}_{re} \\ - sin ( {θ}_{re} - \frac{2}{3} π ) \\ - sin ( {θ}_{re} - \frac{4}{3} π )\end{matrix} ] \qquad Equation ( 1 )$$

Here, equation (1) is a voltage equation in fixed coordinates u, v, w on the rotating machine, and vu, vv, vw represent phase voltages, R represents winding resistance, s represents a differential operator, Lu, Lv, Lw represent self-inductances of windings, Muv, Mvw, Mwu represent mutual inductances between the windings, iu, iv, iw represent phase currents, wre represents electric angular velocity, pmag represents a permanent-magnet magnetic flux, and Ore represents an electric angle position.

The rotating machine 16 is assumed to be a three-phase synchronous motor or a three-phase induction motor, but may be, for example, a double three-phase winding motor, a motor such as a five-phase motor other than three-phase motors, or a field winding motor. In addition, the rotating machine 16 may be, for example, a synchronous reluctance motor, a switched reluctance motor, another synchronous motor, or a motor other than induction motors.

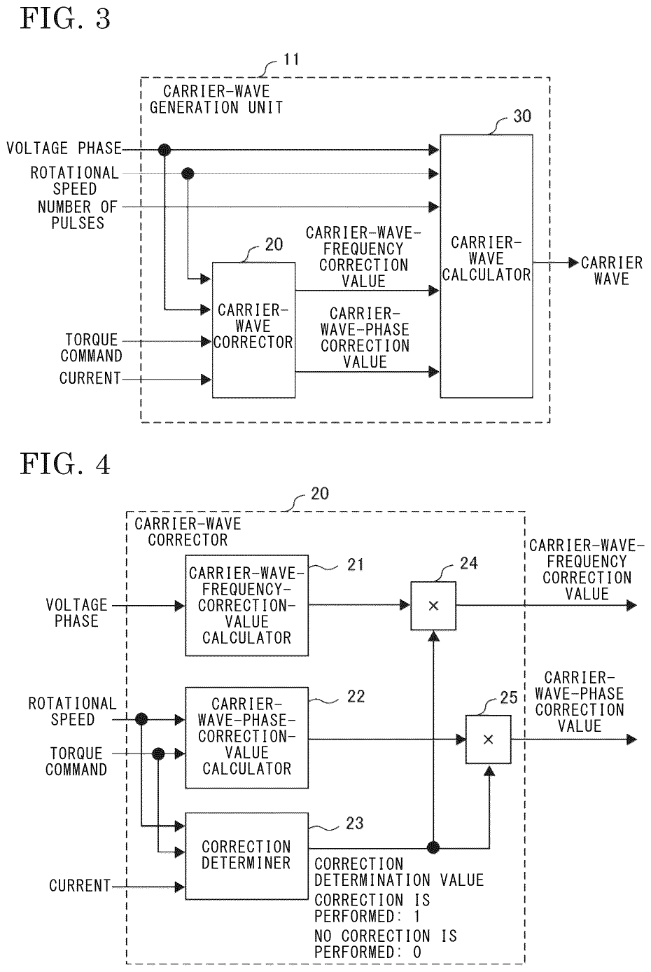

FIG. 3 is a block diagram illustrating the configuration of the carrier-wave generation unit 11. The carrier-wave generation unit 11 includes the carrier-wave corrector 20 and the carrier-wave calculator 30.

The carrier-wave corrector 20 calculates a carrier-wave-frequency correction value and a carrier-wave-phase correction value on the basis of the current information from the current detector 15, and information on the voltage phase, the rotational speed, and the torque command which have been generated by the voltage command generator 10, and outputs the calculated values to the carrier-wave calculator 30.

The carrier-wave calculator 30 corrects a carrier wave as a reference based on the voltage phase, the rotational speed, and the number of pulses which have been generated by the voltage command generator 10, on the basis of the carrier-wave-frequency correction value and the carrier-wave-phase correction value which have been calculated by the carrier-wave corrector 20, to generate a carrier wave. The carrier wave as a reference refers to a carrier wave having a carrier wave frequency that is constant in one cycle of electric angle.

FIG. 4 is a block diagram illustrating an internal configuration of the carrier-wave corrector 20. The carrier-wave corrector 20 includes a carrier-wave-frequency-correction-value calculator 21, a carrier-wave-phase-correction-value calculator 22, a correction determiner 23, and multipliers 24, 25.

The carrier-wave-frequency-correction-value calculator 21 calculates the carrier-wave-frequency correction value on the basis of the voltage phase. With the carrier-wave-frequency correction value, correction is performed to raise or lower the carrier wave frequency such that the number of times of switching (equivalent to wording for the number of pulses or the number of carrier waves) in one cycle of electric angle is not changed or does not undergo change by 20% or more.

That is, with respect to the carrier wave as a reference, correction is performed such that the frequency of the carrier wave is raised by a factor of more than 1.0, at least in a part of a region where the magnitude of the current value in the current information on the rotating machine 16 is more than a predetermined magnitude, and correction is performed such that the frequency of the carrier wave is lowered by a factor of 1.0 or less, at least in a part of a region where the magnitude of the current value in the current information on the rotating machine 16 is less than the predetermined magnitude, or correction is performed such that the frequency of the carrier wave is raised by a factor of 1.0 or more, at least in a part of the region where the magnitude of the current value in the current information on the rotating machine 16 is more than the predetermined magnitude, and correction is performed such that the frequency of the carrier wave is lowered by a factor of less than 1.0, at least in a part of the region where the magnitude of the current value in the current information on the rotating machine 16 is less than the predetermined magnitude.

Alternatively, with respect to the carrier wave as a reference, correction may be performed such that the frequency of the carrier wave is raised by a factor of more than 1.0, at least in a part of a region where the magnitude of the voltage command value for the rotating machine 16 is more than a predetermined magnitude, and correction may be performed such that the frequency of the carrier wave is lowered by a factor of 1.0 or less, at least in a part of a region where the magnitude of the voltage command value for the rotating machine 16 is less than the predetermined magnitude, or
correction may be performed such that the frequency of the carrier wave is raised by a factor of 1.0 or more, at least in a part of the region where the magnitude of the voltage command value for the rotating machine 16 is more than the predetermined magnitude, and correction may be performed such that the frequency of the carrier wave is lowered by a factor of less than 1.0, at least in a part of the region where the magnitude of the voltage command value for the rotating machine 16 is less than the predetermined magnitude.

Specifically, in the present embodiment, the carrier wave frequency of the carrier wave as a reference is corrected to be raised so that peak current becomes small, at least in a part of a region where the amplitude of an AC waveform which is current information is great. The region where the amplitude in the current information is great refers to a region where an instantaneous value in the current information (AC waveform) is not less than a predetermined value with respect to a positive or negative peak value. For example, the value is not less than 90% of the peak value. The expression “at least in a part of the region” is used because it is not necessary that the carrier wave frequency is raised over the entire range of the region where the amplitude in the current information is great, and the correction only has to be performed such that the effect of reducing peak current is increased. In addition, the same also applies to a case where the voltage command value is used instead of the current information. When the voltage command value is used, the voltage command value from the voltage command generator 10 is inputted to the carrier-wave generation unit 11 shown in FIG. 2.

Thus, under a condition that increase in the number of times of switching per cycle of electric angle is suppressed as much as possible, switching is performed so as not to increase peak current in the region where the magnitude of the current value in the current information on the rotating machine is more than the predetermined magnitude, or switching is performed so as not to increase the peak current in the region where the magnitude of the voltage command value for the rotating machine is more than the predetermined magnitude, whereby increase in the peak current is suppressed without increasing loss due to switching operation, so that the rotating machine and the power converter can be protected.

If the carrier wave frequency is merely increased, the number of times of switching per cycle of electric angle is increased. Thus, correction is performed such that the carrier wave frequency of the carrier wave as a reference is lowered in a region where the peak current causes no problem, while the number of times of switching per cycle of electric angle is not increased or does not undergo change by 20% or more. Thus, switching loss can be reduced. The number of times of switching does not undergo change by 20% or more, because a numerical value such as 21, 15, 12, 9, or 6 is normally selected as the number of pulses and control is performed, but, for example, if the number of times of switching is increased by 20% when control is performed at the number of pulses of 12, the number of times of switching is the same as that when control is performed at the number of pulses of 15, so that the effect of not increasing the number of times of switching is reduced.

As an implementation method, such a correction pattern that peak current can be reduced without increase in the number of times of switching may be stored in advance as a map or a function with respect to operating points. Here, as described above, the carrier-wave-frequency-correction-value calculator 21 calculates a correction value on the basis of the voltage phase, but may calculate the correction value on the basis of the current phase, the rotor position, or the like, instead of the voltage phase.

The carrier-wave-phase-correction-value calculator 22 corrects the carrier wave phase to obtain such a carrier wave phase as to reduce peak current, on the basis of the rotational speed and the torque command. Specifically, such carrier wave phases as to reduce peak current are stored as a map or a function with respect to operating points, whereby the carrier-wave-phase correction value is calculated. Here, the carrier-wave-phase-correction-value calculator 22 calculates the correction value on the basis of the rotational speed and the torque command, but may perform calculation on the basis of the voltage command value, the current information, or the like. Thus, the switching phase can be adjusted, so that the effect of suppressing increase in the peak current is enhanced.

The carrier-wave-frequency correction value and the carrier-wave-phase correction value are designed not only to reduce the peak current but also to basically maintain the symmetry of the PWM pulses as much as possible. Specifically, PWM pulses between 0 and 180 degrees and PWM pulses between 180 and 360 degrees in a voltage phase are designed to be point-symmetrical, and, if possible, it is preferable that PWM pulses between 0 degrees and 90 degrees and PWM pulses between 90 degrees and 180 degrees, and PWM pulses between 180 degrees and 270 degrees and PWM pulses between 270 degrees and 360 degrees are also designed to be line-symmetrical.

The correction determiner 23 determines whether or not to perform correction with correction values of the carrier-wave-frequency-correction-value calculator 21 and the carrier-wave-phase-correction-value calculator 22, on the basis of the operating point for the rotational speed, the torque command, the voltage command, or the like, or peak current calculated from the current information on current actually flowing in the rotating machine 16. For example, in a case of an operation point closer to where the peak current becomes a problem or a case where the peak current is closer to an overcurrent threshold than expected, for example, “1” is outputted so as to correct the carrier wave frequency or the phase. Conversely, in a case other than an operation point where the peak current becomes a problem or a case where the peak current is not closer to the overcurrent threshold than expected, for example, “0” is outputted so as not to correct the carrier wave frequency or the phase. As described above, only a specific operating point is targeted, whereby it is unnecessary to perform correction at all the operating points, and a control configuration can be simplified.

The multiplier 24 multiplies output of the carrier-wave-frequency-correction-value calculator 21 by output of the correction determiner 23, to determine the carrier-wave-frequency correction value, and the multiplier 25 multiplies output of the carrier-wave-phase-correction-value calculator 22 by output of the correction determiner 23, to determine the carrier-wave-phase correction value. Here, although the multipliers are used, instead of the multipliers, other means such as an adder-subtractor or a divider (e.g., a function or a map) may be used.

In the present configuration, correction is performed to obtain such a carrier wave frequency and a phase as to reduce peak current. However, the carrier wave frequency and the phase may be corrected so as to reduce current harmonics, voltage harmonics, vibration, or heat, besides the peak current.

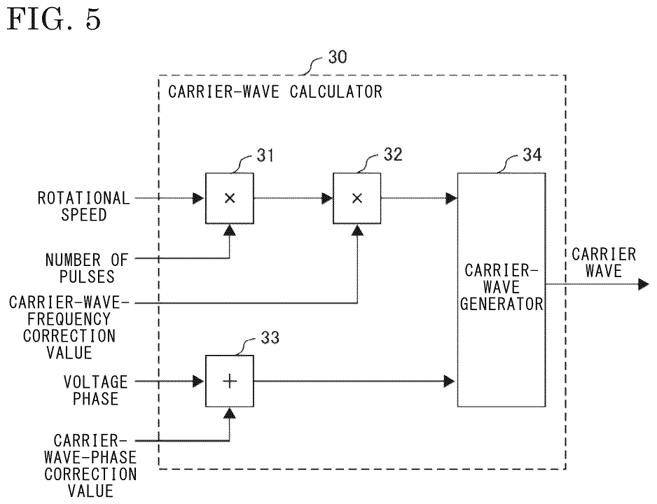

FIG. 5 is a block diagram illustrating an internal configuration of the carrier-wave calculator 30. The carrier-wave calculator 30 includes multipliers 31, 32, an adder 33, and a carrier-wave generator 34.

The multiplier 31 multiplies the rotational speed and the number of pulses which have been generated by the voltage command generator 10, to calculate a carrier wave frequency as a reference. The multiplier 32 multiplies the carrier wave frequency outputted from the multiplier 31 by the carrier-wave-frequency correction value calculated by the carrier-wave-frequency-correction-value calculator 21, and outputs a carrier wave frequency. The carrier wave frequency as a reference refers to a carrier wave frequency that is constant in one cycle of electric angle. Instead of the multiplier 31, other means such as an adder-subtractor and a divider (e.g., a function or mapping) may be used. The carrier wave frequency as a reference is a product of a coefficient and the frequency of the voltage command value. When the carrier-wave-frequency correction value is multiplied by the multiplier 32, the carrier wave frequency as a reference is further multiplied by a coefficient.

The adder 33 adds the voltage phase generated by the voltage command generator 10 and the carrier-wave-phase correction value calculated by the carrier-wave-phase-correction-value calculator 22, and outputs a carrier wave phase synchronized with the voltage phase. Instead of the adder 33, other means such as a subtractor, a divider, or a multiplier (e.g., a function or mapping) may be used.

The carrier-wave generator 34 generates and outputs a carrier wave synchronized with the voltage phase, on the basis of the carrier wave frequency outputted from the multiplier 32 and the carrier wave phase outputted from the adder 33. A triangular wave is often used for the carrier wave, but a saw-tooth wave, a sine wave, or a rectangular wave may be used.

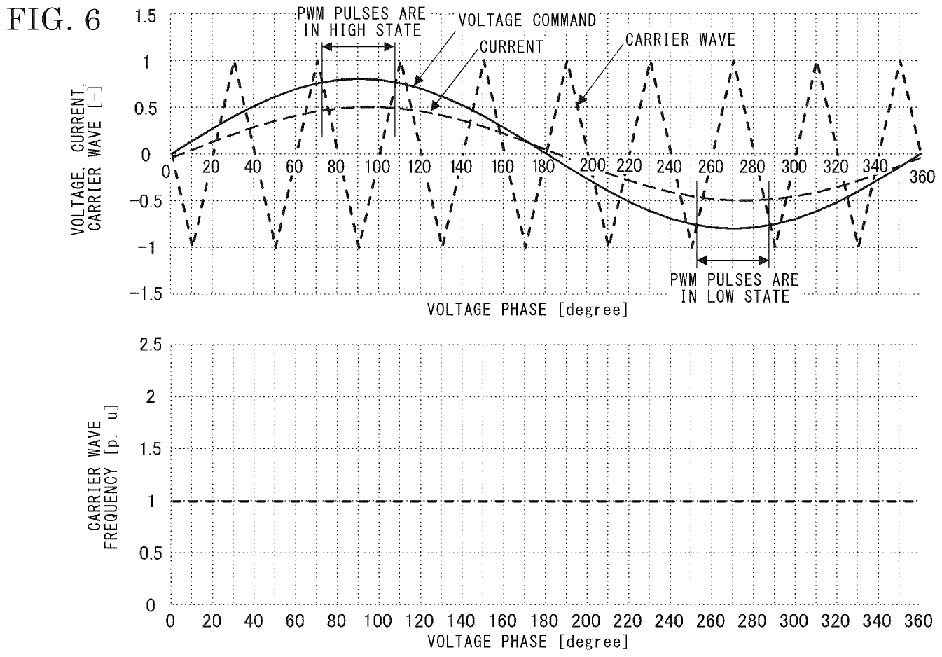

FIG. 6 shows a voltage command value, current, a carrier wave, and a carrier wave frequency in a rotating machine control device as a comparative example not including the carrier-wave corrector 20. FIG. 6 shows an example in which a triangular wave is used as the carrier wave and the number of pulses is set to 9. The voltage command value and the carrier wave are synchronous with each other, and the carrier wave frequency is constant.

In this comparative example, the PWM pulses are generated through comparison of the magnitudes of the carrier wave and the voltage command value. The PWM pulses indicate two values: a high value indicated when the magnitude of the voltage command value is greater than that of the carrier wave; and a low value indicated when the magnitude of the voltage command value is smaller than that of the carrier wave. In this case, the PWM pulse is in a high state in a certain section around a positive peak of current, and is in a low state in a certain section around a negative peak of current. That is, the PWM pulses are in a high state around the positive peak of current and thus serve as a command to increase current in the positive direction, and the PWM pulses are in a low state around the negative peak of current and thus serve as a command to increase current in the negative direction, so that the peak current is increased.

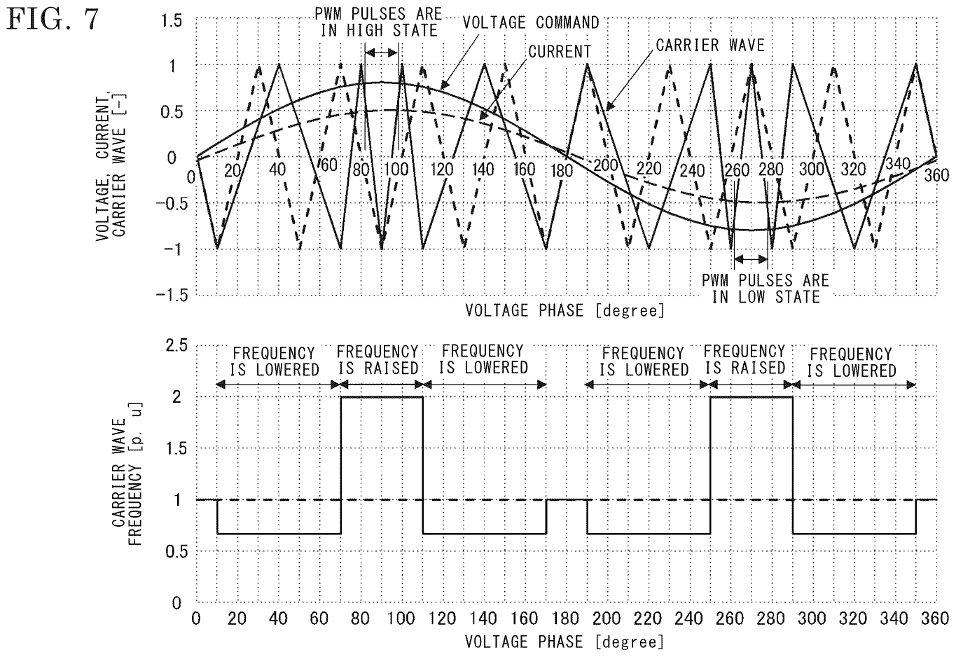

Meanwhile, FIG. 7 shows the voltage command value, the current, the carrier wave, and the carrier wave frequency in the rotating machine control device 1 of the present embodiment. Compared to FIG. 6, one example in which the carrier wave frequency is corrected by using the carrier-wave corrector 20 is shown. At this time, in a part of a region where the magnitude of the current value of phase current is great, that is, in the present embodiment, a region approximately from 70 degrees to 110 degrees and a region approximately from 250 degrees to 290 degrees, which are regions from −20 degrees to +20 degrees around peak values, the carrier wave frequency is doubled and high. Thus, compared to FIG. 6, a section (from about 80 degrees to about 100 degrees) which is close to a positive peak of current and in which PWM pulses are in a high state, and a section (from around 260 degrees to around 280 degrees) which is close to a negative peak of current and in which PWM pulses are in a low state, can be shortened, so that increase in the peak current can be suppressed. Meanwhile, in a part of a region where the magnitude of the current value is small, that is, in the present embodiment, regions other than the above-described regions, which are a region from 10 degrees to 70 degrees, a region from 110 degrees to 170 degrees, a region from 190 degrees to 250 degrees, and a region from 290 degrees to 350 degrees, the carrier wave frequency is 0.6 times and low. Thus, the number of pulses and the number of the carrier waves in one cycle of electric angle are not changed. In such a correction method, the peak current can be reduced without increasing the number of times of switching. A selection of a region where the current value is great and the carrier wave frequency is raised, and a selection of how much the frequency is raised are not limited to the above description, and any selection method may be used as long as increase in the peak current can be suppressed.

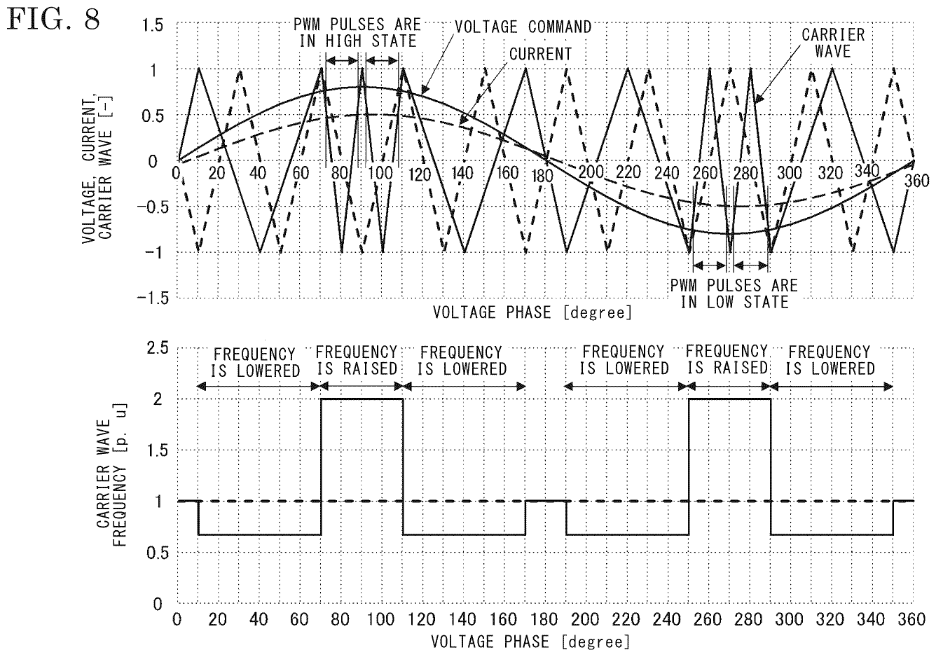

Compared to the configuration of FIG. 7, FIG. 8 shows an example in which not only the carrier wave frequency but also the carrier wave phase is corrected. At this time, correction of the carrier wave frequency is the same as that in FIG. 7, but the carrier wave phase is corrected by 180 degrees compared to that in FIG. 7. When the carrier wave phase is corrected as shown in FIG. 8, regions in which the carrier wave frequency is raised are the same as those in FIG. 7, but the PWM pulses are in a low state in a certain section (approximately a several-degree range around 90 degrees in the present embodiment) close to a positive peak of current, and the PWM pulses are in a high state in a certain section (approximately a several-degree range around 270 degrees in the present embodiment) close to a negative peak of current. This is based on the principle that current is changed in an increasing direction when the PWM pulses are in a high state, and current is changed in a decreasing direction when the PWM pulses are in a low state. Thus, a configuration in FIG. 8 in which the carrier wave phase is corrected can further reduce the peak current than that in FIG. 7. As described above, not only the carrier wave frequency but also the carrier wave phase is corrected, so that the effect of reducing the peak current can be further enhanced. Each angle shown in the above is an example.

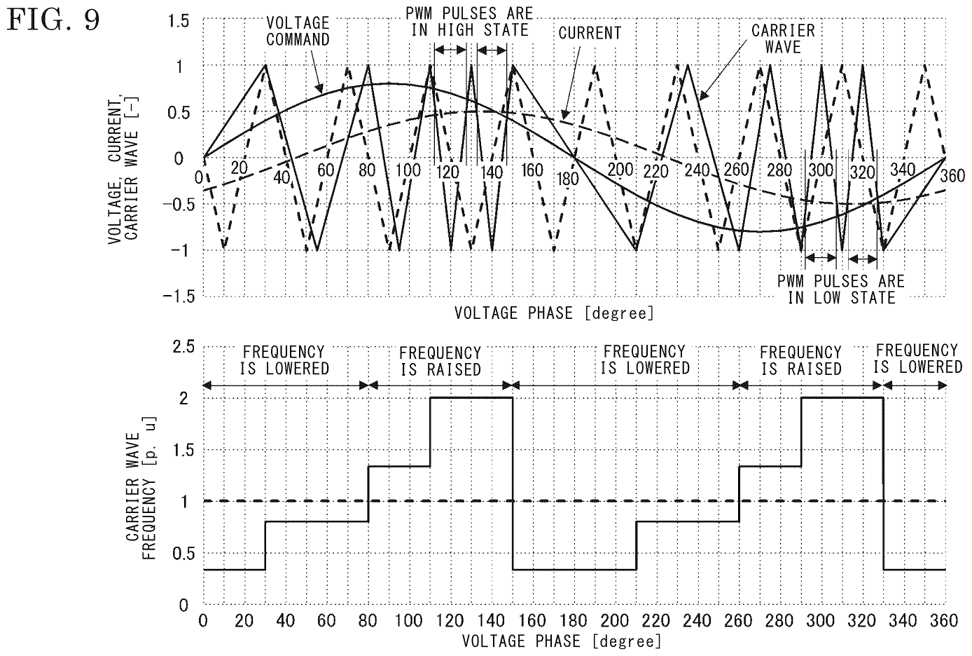

FIG. 9 shows an example in which the carrier wave frequency and the carrier wave phase are corrected, when a phase difference between voltage and current is great, e.g., when the phase difference is 50 degrees. Also, when a phase difference between voltage and current is great, the carrier wave frequency is corrected such that, as in FIG. 8, the carrier wave frequency is raised in sections around the peaks of current, i.e., in FIG. 9, 70-degree ranges (from 80 degrees to 150 degrees and from 260 degrees to 330 degrees) around the peak value, and the carrier wave frequency is lowered in other ranges. The carrier wave phase is also corrected such that the PWM pulses are in a low state in a certain section (a several-degree range around 130 degrees in the present embodiment) close to a positive peak of current, and such that the PWM pulses are in a high state in a certain section (a several-degree range around 310 degrees in the present embodiment) close to a negative peak of current, so that the effect of reducing the peak current is enhanced. Each angle shown in the above is an example.

In FIG. 7, FIG. 8, and FIG. 9, the carrier wave frequency is corrected at a timing of the top or the bottom thereof, but the carrier wave frequency may be corrected at other timings. In addition, since correction values for the carrier wave frequency and the phase are examples, values other than those described in FIGS. 7, 8, and 9 may be set.

In FIG. 7 and FIG. 8, the PWM pulse waveform from 0 degrees to 180 degrees in a voltage phase and the PWM pulse waveform from 180 degrees to 360 degrees in a voltage phase are offset in point symmetry, to suppress occurrence of even-order harmonics, and the voltage pulses from 0 degrees to 90 degrees and the voltage pulses from 90 degrees to 180 degrees, and the voltage pulses from 180 degrees to 270 degrees and the voltage pulses from 270 degrees to 360 degrees, are set in line symmetry to express a waveform of a sine wave. In FIG. 9, the PWM pulse waveform from 0 degrees to 180 degrees in a voltage phase and the PWM pulse waveform from 180 degrees to 360 degrees in a voltage phase are designed to be point-symmetrical, but the carrier wave frequency and the phase may be corrected so as not to maintain the symmetry.

In FIG. 7, FIG. 8, and FIG. 9, the correction value for the carrier wave frequency is a second-order component in one cycle of electric angle, but may be set to be a third-order component or the like such that the carrier wave shapes between three phases are identical.

Although the disclosure is described above in terms of an exemplary embodiment, it should be understood that the various features, aspects, and functionality described in the embodiment are not limited in their applicability to the particular embodiment with which they are described, but instead can be applied alone or in various combinations to the embodiment of the disclosure. It is therefore understood that numerous modifications which have not been exemplified can be devised without departing from the scope of the present disclosure. For example, at least one of the constituent components may be modified, added, or eliminated.

### DESCRIPTION OF THE REFERENCE CHARACTERS

1 rotating machine control device
2 processor
3 storage device
10 voltage command generator
11 carrier-wave generation unit
12 comparator
13 DC power supply
14 power converter
15 current detector
16 rotating machine
20 carrier-wave corrector
21 carrier-wave-frequency-correction-value calculator
22 carrier-wave-phase-correction-value calculator
23 correction determiner
24, 25 multiplier
30 carrier-wave calculator
31, 32 multiplier
33 adder
34 carrier-wave generator

1. A rotating machine control device for applying AC voltage converted from DC voltage through a power converter, to a rotating machine, the rotating machine control device comprising:
a voltage command generator which generates a voltage command value;
a carrier-wave generator which generates a carrier wave; and
a comparator which determines switching operation of the power converter using the voltage command value and output of the carrier-wave generator, wherein
the carrier-wave generator includes a carrier-wave corrector which corrects a frequency of a carrier wave as a reference,
with respect to the frequency of the carrier wave as the reference,
in a manner such that a number of times of the switching operation in one cycle of electric angle is constant or at least does not undergo change by 20% or more as compared to the number of times of the switching operation before correction,
the carrier-wave corrector performs correction such that a frequency of the carrier wave is raised by a factor of more than 1.0, at least in a part of a region where a magnitude of a current value in current information on the rotating machine is more than a predetermined magnitude, and
performs correction such that the frequency of the carrier wave is lowered by a factor of 1.0 or less, at least in a part of a region where the magnitude of the current value in the current information on the rotating machine is less than the predetermined magnitude, or
the carrier-wave corrector performs correction such that the frequency of the carrier wave is raised by a factor of 1.0 or more, at least in a part of the region where the magnitude of the current value in the current information on the rotating machine is more than the predetermined magnitude, and
performs correction such that the frequency of the carrier wave is lowered by a factor of less than 1.0, at least in a part of the region where the magnitude of the current value in the current information on the rotating machine is less than the predetermined magnitude, and
the carrier-wave corrector corrects a phase of the carrier wave so as to change a phase difference between the voltage command value and the carrier wave, on the basis of one or more of at least a rotational speed of the rotating machine, a torque command, the voltage command value, and the current information on the rotating machine.

2. A rotating machine control device for applying AC voltage converted from DC voltage through a power converter, to a rotating machine, the rotating machine control device comprising:
a voltage command generator which generates a voltage command value;
a carrier-wave generator which generates a carrier wave; and
a comparator which determines switching operation of the power converter using the voltage command value and output of the carrier-wave generator, wherein
the carrier-wave generator includes a carrier-wave corrector which corrects a frequency of a carrier wave as a reference,
with respect to the frequency of the carrier wave as the reference,
in a manner such that a number of times of the switching operation in one cycle of electric angle is constant or at least does not undergo change by 20% r more as compared to the number of times of the switching operation before correction,
the carrier-wave corrector performs correction such that a frequency of the carrier wave is raised by a factor of more than 1.0, at least in a part of a region where a magnitude of the voltage command value for the rotating machine is more than a predetermined magnitude, and
performs correction such that the frequency of the carrier wave is lowered by a factor of 1.0 or less, at least in a part of a region where the magnitude of the voltage command value for the rotating machine is less than the predetermined magnitude, or
the carrier-wave corrector performs correction such that the frequency of the carrier wave is raised by a factor of 1.0 or more, at least in a part of the region where the magnitude of the voltage command value for the rotating machine is more than the predetermined magnitude, and
performs correction such that the frequency of the carrier wave is lowered by a factor of less than 1.0, at least in a part of the region where the magnitude of the voltage command value for the rotating machine is less than the predetermined magnitude, and
the carrier-wave corrector corrects a phase of the carrier wave so as to change a phase difference between the voltage command value and the carrier wave, on the basis of one or more of at least a rotational speed of the rotating machine, a torque command, the voltage command value, and the current information on the rotating machine.

3.-4. (canceled)

5. The rotating machine control device according to claim 1, wherein
the carrier-wave corrector includes a correction determiner which determines whether or not to correct a frequency and a phase of the carrier wave, and
the correction determiner determines whether or not to perform correction, on the basis of one or more of at least the rotational speed of the rotating machine, the torque command, the voltage command value, and the current information on the rotating machine.

6. The rotating machine control device according to claim 1, wherein
the carrier-wave generator includes a carrier-wave calculator, and
the carrier-wave calculator calculates the carrier wave on the basis of: the carrier wave frequency as the reference which has been calculated from the rotational speed of the rotating machine and the number of pulses determined on the basis of the rotational speed, and which is a product of a coefficient and a frequency of the voltage command value; and a correction value from the carrier-wave corrector.

7. The rotating machine control device according to claim 1, wherein
as the current information on the rotating machine, a detected-current value detected by a current detector, a current command value, or an estimated-current value estimated or predicted from rotating machine characteristics of the rotating machine, is used.

8. The rotating machine control device according to claim 1, wherein
the region where the magnitude is more than the predetermined magnitude is a region from −20 degrees to +20 degrees around a peak value of AC current flowing in the rotating machine.

9. The rotating machine control device according to claim 1, wherein
the region where the magnitude is more than the predetermined magnitude is a region in a 70-degree range around a peak value of AC current flowing in the rotating machine when a phase difference between the voltage command value and the current information is more than 50 degrees.

10. The rotating machine control device according to claim 2, wherein
the carrier-wave corrector includes a correction determiner which determines whether or not to correct a frequency and a phase of the carrier wave, and
the correction determiner determines whether or not to perform correction, on the basis of one or more of at least the rotational speed of the rotating machine, the torque command, the voltage command value, and the current information on the rotating machine.

11. The rotating machine control device according to claim 2, wherein
the carrier-wave generator includes a carrier-wave calculator, and
the carrier-wave calculator calculates the carrier wave on the basis of: the carrier wave frequency as the reference which has been calculated from the rotational speed of the rotating machine and the number of pulses determined on the basis of the rotational speed, and which is a product of a coefficient and a frequency of the voltage command value; and a correction value from the carrier-wave corrector.

12. The rotating machine control device according to claim 2, wherein
as the current information on the rotating machine, a detected-current value detected by a current detector, a current command value, or an estimated-current value estimated or predicted from rotating machine characteristics of the rotating machine, is used.

13. The rotating machine control device according to claim 2, wherein
the region where the magnitude is more than the predetermined magnitude is a region from −20 degrees to +20 degrees around a peak value of AC current flowing in the rotating machine.

14. The rotating machine control device according to claim 2, wherein
the region where the magnitude is more than the predetermined magnitude is a region in a 70-degree range around a peak value of AC current flowing in the rotating machine when a phase difference between the voltage command value and the current information is more than 50 degrees.
